(19) United States
(12) Patent Application Publication
(10) Pub. No.: US 2018/0107589 A1
(43) Pub. Date: Apr. 19, 2018

(54) APPLICATION STORE OPTIMIZATION

(71) Applicant: TUNE, Inc., Seattle, WA (US)

(72) Inventors: Ian Fletcher Sefferman, Seattle, WA (US); Patrick Robert Haig, Seattle, WA (US); Adam Douglass Saegebarth, Seattle, WA (US)

(21) Appl. No.: 15/294,616

(22) Filed: Oct. 14, 2016

(51) Int. Cl. G06F 11/36; G06F 9/445

(52) U.S. Cl. CPC G06F 11/3688; G06F 8/61

(57) ABSTRACT

Embodiments are directed to managing user interactions with applications. If a user employs a client computer to interact with a testing environment test events may be provided to a measurement engine based on user interactions, such that, the test events may include device identifiers associated with the client computer. If the user interacts with the application on the client computer separate from the testing environment application events may be provided to the measurement engine based on user interactions with the application, such that, the application events include the device identifiers. The measurement engine may be employed to correlate the test events with the application events based on the device identifiers. Reports associated events and user interaction with the application may be provided.

### TECHNICAL FIELD

This invention relates generally to application monitoring services, and more particularly, but not exclusively, to measuring the user interactions with applications.

### BACKGROUND

The marketplace for applications is becoming increasingly competitive. Consumers have millions of different applications for many different platforms to choose from. In response to the explosion of the number of applications and market congestion, marketing services organizations have stepped forward to provide a variety of services to help application developers understand the marketplace in general as well as provide a better understanding of how their own customers (and potential customers) are responding to their offerings.

Accordingly, various user tracking solutions have been offered by marketing services organizations to provide information regarding how users interact with their applications. For example, organizations may track the web navigation history of users to determine information about their interests and/or interaction habits. Information gleaned from the tracking a user's web activity may be used to influence the how applications are designed and/or promoted. To help understand user interactions with their applications, organizations may provide testing platforms that application developers to test various application designs and promotions campaigns and compare the results. However, as some campaigns and/or user activities may span more than one communication domain (e.g., web, mobile, print, or the like) it may be difficult to effectively evaluate user interactions occurring across multiple domains. Thus, it is with respect to these considerations and others that the invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Description of Various Embodiments, which is to be read in association with the accompanying drawings, wherein:

FIG. 1 illustrates a system environment in which various embodiments may be implemented;

FIG. 2 shows a logical schematic embodiment of a client computer;

FIG. 3 illustrates a logical schematic embodiment of a network computer;

FIG. 4 illustrates a logical schematic of an analytics system in accordance with at least one of the various embodiments;

FIG. 5 illustrates a logical architecture for a compact referential data store in accordance with at least one of the various embodiments;

FIG. 6 illustrates an overview flowchart for a process for application store optimization in accordance with at least one of the various embodiments;

FIG. 7 illustrates an overview flowchart for a process for collecting test measurements for application store optimization in accordance with at least one of the various embodiments;

FIG. 8 illustrates an overview flowchart for a process for collecting test measurements for application store optimization in accordance with at least one of the various embodiments; and

FIG. 9 illustrates an overview flowchart for a process for collecting test measurements for application store optimization in accordance with at least one of the various embodiments

### DETAILED DESCRIPTION OF EMBODIMENTS OF THE INVENTION

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. Also, throughout the specification and the claims, the use of “when” and “responsive to” do not imply that associated resultant actions are required to occur immediately or within a particular time period. Instead they are used herein to indicate actions that may occur or be performed in response to one or more conditions being met, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing user interactions with applications over a network using a network computer having one or more processors that perform actions, as described below. In at least one of the various embodiments, if a user employs a client computer to interact with an entry point to a testing environment various actions may be performed.

In at least one of the various embodiments, one or more test events may be provided to a measurement engine based on one or more user interactions with the testing environment, such that, the one or more test events may include at least one or more device identifiers that may be associated with the client computer. In at least one of the various embodiments, providing the one or more test events, may include providing at least one test event that may correspond to the user requesting to install the application. Accordingly, in at least one of the various embodiments, a testing engine may be employed to redirect the client computer to an application store that offers the application, such that the application store may be separate from the testing engine and the measurement engine.

In at least one of the various embodiments, a non-transitory computer readable media may be configured and arranged to store the one or more test events.

In at least one of the various embodiments, if the user interacts with the application on the client computer separate from the testing environment, additional actions may be performed.

In at least one of the various embodiments, one or more application events may be provided to the measurement engine based on one or more other user interactions with the application, such that, the one or more application events include at least the one or more device identifiers.

In at least one of the various embodiments providing the one or more application events to the measurement engine, may include, providing user interaction information to a metrics engine on the client computer, where the metrics engine may be included in the application. Accordingly, in some embodiments, the metrics engine may be employed to generate the one or more application events. And, in some embodiments, the metrics engine may be employed to communicate the one or more application events to the measurement engine.

In at least one of the various embodiments, the measurement engine may be employed to correlate the one or more test events with the one or more application events based on the one or more device identifiers.

In at least one of the various embodiments, one or more reports associated with the application may be provided, such that the reports include information that may be based on the one or more test events, the one or more application events, or the like. In at least one of the various embodiments, providing the one or more reports may include, providing a list of client computers that provided one or more of the one or more application events absent a test event corresponding to a request to install the subject application.

In at least one of the various embodiments, a testing engine may be employed to provide the testing environment that may be associated with the application.

In at least one of the various embodiments, a fingerprint of the client computer may be provided based on one or more characteristics of the client computer or the one or more user interactions, such that the one or more device identifiers may be derived from at least a portion the fingerprint.

In at least one of the various embodiments, one or more metrics based on the one or more test events and the one or more application events may be provided. In some embodiments, the one or more metrics may be packed into one or more compressed fields. Accordingly, in at least one of the various embodiments, the one or more compressed fields may be stored in a record that may be associated with the application.

In at least one of the various embodiments, the testing engine may be employed to register the client computer with the measurement engine.

### Illustrated Operating Environment

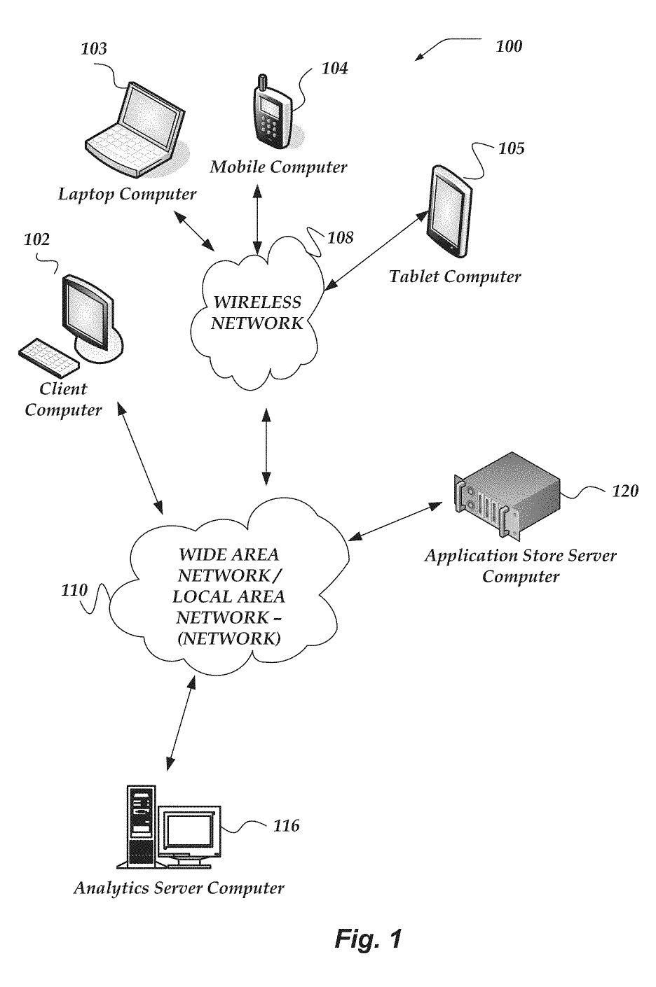

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/ wide area networks (WANs)—(network) 110, wireless network 108, client computers 102-105, analytics server computer 116, application store server computer 120, or the like.

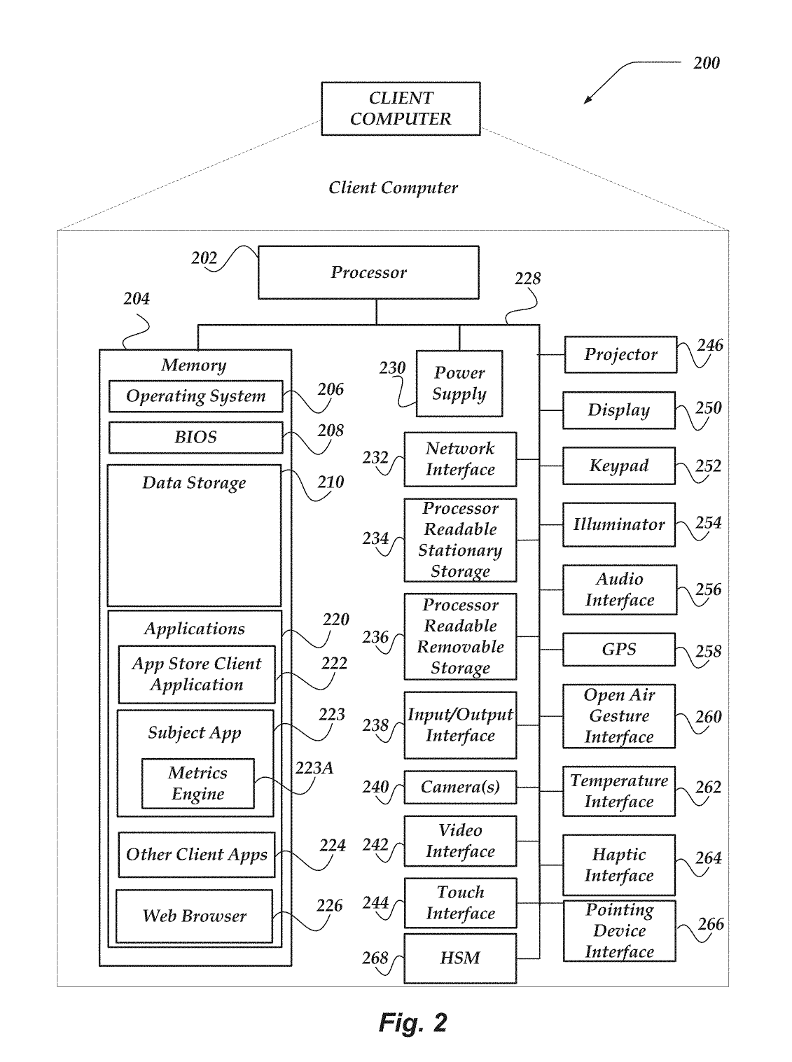

At least one embodiment of client computers 102-105 is described in more detail below in conjunction with FIG. 2. In one embodiment, at least some of client computers 102-105 may operate over one or more wired and/or wireless networks, such as networks 108, and/or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), JavaScript Object Notation (JSON), or the like, to display and send a message. In one embodiment, a user of the client computer may employ the browser application to perform various activities over a network (online). However, one or more other applications may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), one or more identifiers for advertising (IFAs), or other device identifier. Such information may be provided in a message comprised of one or more network packets, or the like, sent between other client computers, analytics server computer 116, application store server computer 120, or other computers. In some embodiments, the one or more processors of analytics server computer 116 may be arranged to perform one or more specific tasks for providing analytics associated with marketing services as described in detail below.

Client computers 102-105 may further be configured to include a client application that enables an end-user to log into an end-user account that may be managed by another computer, such as analytics server computer 116, advertising network server computer 118, application store server computer 120, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, analytics server computer 116, application store server computer 120, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

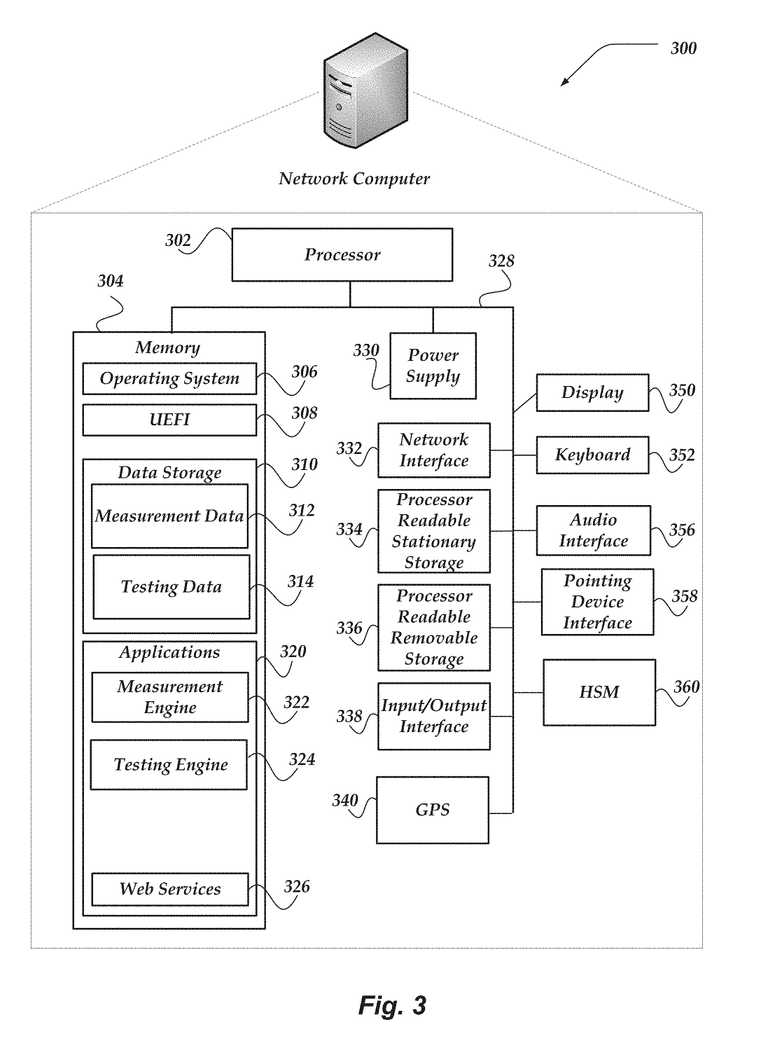

One embodiment of analytics server computer 116 is described in more detail below in conjunction with FIG. 3. Briefly, however, analytics server computer 116 includes virtually any network computer capable of providing, managing, or reporting analytics associated with marketing services.

Although FIG. 1 illustrates analytics server computer 116, application store server computer 120 each as a single computer, the innovations and/or embodiments are not so limited. For example, one or more functions of analytics server computer 116, application store server computer 120, or the like, may be distributed across one or more distinct network computers. Moreover, analytics server computer 116, application store server computer 120 are not limited to a particular configuration such as the one shown in FIG. 1. Thus, in one embodiment, one or more of analytics server computer 116, application store server computer 120 may be implemented using a plurality of network computers. In other embodiments, server computers may operate as a plurality of network computers within a cluster architecture, a peer-to-peer architecture, or the like. Further, in at least one of the various embodiments, analytics server computer 116, application store server computer 120 may be implemented using one or more cloud instances in one or more cloud networks.

Also, in at least one of the various embodiments, one or more analytics server computers, or at least some or all of the features thereof, may be incorporated in application store server computer 120. Accordingly, these innovations and embodiments are not to be construed as being limited to a single environment, and other configurations, and architectures are also envisaged.

Illustrative Client computer

FIG. 2 shows one embodiment of client computer 200 that may include many more or less components than those shown. Client computer 200 may represent, for example, at least one embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring and/or maintaining an orientation of client computer 200.

Power supply 230 may provide power to client computer 200. In some cases, a rechargeable or non-rechargeable battery may be used to provide power. The power may also be provided by an external power source, such as an AC adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to event messages. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing and/or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, and/or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input and/or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In at least one embodiment, however, client computer 200 may, through other components, provide other information that may be employed to determine a physical location of the client computer, including for example, a Media Access Control (MAC) address, IP address, and the like.

Human interface components can be peripheral devices that are physically separate from client computer 200, allowing for remote input and/or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, and/or otherwise process instructions and data. Applications 220 may include, for example, application store client application 222, subject application 223, other client applications 224, web browser 226, or the like. Client computers may be arranged to exchange communications, such as, queries, searches, messages, notification messages, event messages, alerts, performance metrics, log data, API calls, or the like, combination thereof, with application servers, network file system applications, analytics applications, or the like.

Subject application 223 represents one or more applications that may be installed on client computer 200 by a user, or other provider. In some cases, subject application 223 represents one or more applications provided by an application store server computer, such as, application store service computer 120. Subject application 223 represents an application that is arranged to capture user interaction information. Metrics engine 223A represent a module or library installed as part of subject application 223 that facilitates capturing user interaction information and providing it to an analytics server computer, such as, analytics server computer 116. In some embodiments, metrics engine 223A may be installed separately from subject application 223. Also, for some subject applications, metric engine 223A may be arranged to execute on client computer 200 separate from subject application 223.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include a hardware microcontroller instead of a CPU. In at least one embodiment, the microcontroller may directly execute its own embedded logic to perform actions and access its own internal memory and its own external Input and Output Interfaces (e.g., hardware pins and/or wireless transceivers) to perform actions, such as System On a Chip (SOC), or the like.

### Illustrative Network Computer

FIG. 3 shows one embodiment of network computer 300 that may be included in a system implementing at least one of the various embodiments. Network computer 300 may include many more or less components than those shown in FIG. 3. However, the components shown are sufficient to disclose an illustrative embodiment for practicing these innovations. Network computer 300 may represent, for example, one embodiment of one or more of analytics server computer 116, or application store server computer 120 of FIG. 1.

As shown in the figure, network computer 300 includes a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. Display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to network computer 300. Human interface components can be physically separate from network computer 300, allowing for remote input and/or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In at least one embodiment, however, network computer 300 may, through other components, provide other information that may be employed to determine a physical location of the client computer, including for example, a Media Access Control (MAC) address, IP address, and the like.

Memory 304 may include Random Access Memory (RAM), Read-Only Memory (ROM), and/or other types of memory. Memory 304 illustrates an example of computer-readable storage media (devices) for storage of information such as computer-readable instructions, data structures, program modules or other data. Memory 304 stores a Unified Extensible Firmware Interface (UEFI) 308 for controlling low-level operation of network computer 300. The memory also stores an operating system 306 for controlling the operation of network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs. Likewise, other runtime environments may be included.

Memory 304 may further include one or more data storage 310, which can be utilized by network computer 300 to store, among other things, applications 320 and/or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by one or more processors, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, measurement data 312, testing data 314, or the like. measurement data 312 may be one or more data stores that include one or more records, logs, events, file system entries, databases, or the like, associated with analytics. In some embodiments, data storage 310 may also include testing data 314. Testing data 314 may include one or more records, logs, events, file system entries, databases, or the like, associated with testing marketing services.

Applications 320 may include computer executable instructions which, when executed by network computer 300, transmit, receive, and/or otherwise process messages (e.g., SMS, Multimedia Messaging Service (MMS), Instant Message (IM), email, and/or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, web services 326, and so forth. Applications 320 may include measurement engine 322, and/or testing engine 324 that may be arranged to perform actions further described below. In at least one of the various embodiments, one or more of the applications may be implemented as modules and/or components of another application. Further, in at least one of the various embodiments, applications may be implemented as operating system extensions, modules, plugins, or the like.

Furthermore, in at least one of the various embodiments, measurement engine 322, and/or testing engine 324 may be operative in a cloud-based computing environment. In at least one of the various embodiments, these applications, and others, may be executing within virtual machines and/or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines and/or virtual servers dedicated to measurement engine 322, and/or testing engine 324 may be provisioned and de-commissioned automatically.

Also, in at least one of the various embodiments, measurement engine 322, and/or testing engine 324, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing and/or using security/cryptographic information such as, keys, digital certificates, passwords, passphrases, two-factor authentication information, or the like. In some embodiments, hardware security module may be employ to support one or more standard public key infrastructures (PKI), and may be employed to generate, manage, and/or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), the network computer may include one or more embedded logic hardware devices instead of one or more CPUs, such as, an Application Specific Integrated Circuits (ASICs), Field Programmable Gate Arrays (FPGAs), Programmable Array Logics (PALs), or the like, or combination thereof. The embedded logic hardware devices may directly execute embedded logic to perform actions. Also, in one or more embodiments (not shown in the figures), the network computer may include one or more hardware microcontrollers instead of a CPU. In at least one embodiment, the one or more microcontrollers may directly execute their own embedded logic to perform actions and access their own internal memory and their own external Input and Output Interfaces (e.g., hardware pins and/or wireless transceivers) to perform actions, such as System On a Chip (SOC), or the like.

### Illustrative Logical System Architecture

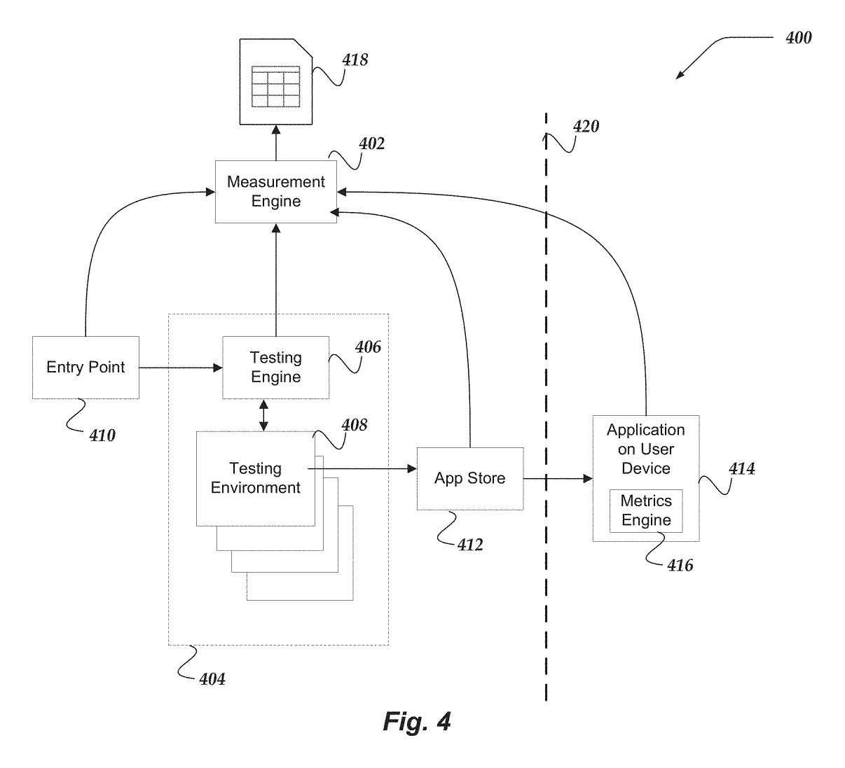

FIG. 4 illustrates a logical schematic of analytics system 400 in accordance with at least one of the various embodiments. In at least one of the various embodiments, analytics system 400 may be arranged to include measurement engine 402 and testing system 404. In at least one of the various embodiments, testing system 404 may be arranged to include testing engine 406 and one or more testing environments, such as, testing environments 408. Also, in at least one of the various embodiments, analytics system 400 may include entry point 410, application store 412, application 414 (including metrics engine 416), analytics report 418, or the like. Also, in this illustration, boundary 420 represents that the installed application. Application 414 is separated from test system 404 and app store 412 by virtue of being installed on a user's client computer.

In at least one of the various embodiments, analytics system 400 may be arranged to monitor and track user interaction with various applications that may be provided to one or more of their client computers, including mobile computers (e.g., smart phones). In some embodiments, analytics system 400 may collect information and/or metrics that enable stakeholders, such as, application developers, advertisers, advertising platforms, or the like, to gain insight into the effectiveness of different application layout/design, advertising campaigns, advertisement delivery methods, or the like.

Further, in at least one of the various embodiments, analytics system 400 may be arranged to enable the various stakeholders to create one or more experiments to test the effectiveness of various advertisements, application designs, or the like, or combination thereof. In some embodiments, a testing engine, such as, testing engine 406 may be arranged to provide experiments for testing the effectives of different application store purchase user-interfaces for various applications.

In at least one of the various embodiments, application developments, marketers, or the like, may distribute their products on one or more different application online stores. In some cases, these online application stores may be operated by other companies/organizations that provided searchable catalogs that consumers may use for downloading and/or purchasing applications.

Also, in some embodiments, online application stores (e.g., app stores) may provide an application store page (e.g. landing page) that describes the offered application and may provide various features such as consumer reviews, screen shots, videos, or the like. Also, the app store page often provides user-interface controls enabling a consumer to buy and/or download the offered application to one or more of their computers, including client computers, mobile computers, smartphones, or the like.

Further, in some embodiments, app stores may enable application developers to customize various aspects of the app store page for their offered applications. The extent of customization allowed may be defined or restricted by the operator of the app store. For example, in some embodiments, the customization may be limited to description text, screenshot selection, developer logos, icons, or the like. However, in some cases, app stores may enable more extensive landing page customization that may include background images, color scheme selection, button placement, or the like. One of ordinary skill in the art will appreciate that it is envisaged that a given app store may enable various limited or extensive customization features that may be different than what is described herein.

In at least one of the various embodiments, application developers and/or marketers may design one or more experiments, such as, various randomized testing style experiments, to test the effectiveness of different app store landing pages. Accordingly, in some embodiments, test engine 406 may be arranged to execute one or more landing page experiments in one or more test environments, such as testing environments 408.

In at least one of the various embodiments, testing engine 406 may be arranged to provide one or more experiments for testing landing pages, such as, AB testing, multi-armed bandit experiments, other multivariate testing, or the like. Accordingly, test environments, such as, testing environment 408 may be comprised of multiple landing pages where the particular landing page provided to a visiting user may be selected based on the experiment that may be managed by testing engine 406.

In at least one of the various embodiments, testing engine 406 may track user actions that occur in testing environment 408 and communicate one or more associated metrics to measurement engine 402. For example, in some embodiments, testing engine 406 may be arranged to track whether users elect to purchase an application promoted by a given landing page. Thus, as users are directed to the testing environment, various metrics may be accumulated for evaluating the effectiveness of particular landing pages. For example, in some embodiments, testing engine 406 may be arranged to track which users request to purchase the offered application. Other metrics may be collected, such as, tracking the activities of the user on each test page (e.g., reading reviews, viewing screenshots, viewing videos, reading expanded descriptions, or the like), user abandonments (e.g., back-outs), time-on-page, or the like.

In at least one of the various embodiments, users may be directed to testing system 404 using entry point 410. In at least one of the various embodiments, entry point 410 represents how the user arrived at testing system 404. For example, entry point 410 may represent one or more URL's provided by online advertisements, emails, SMS texts, or the like. In some embodiments, entry point 410 may be provided by an intermediary, such as, wireless carriers, web services, advertising platforms, marketers, or the like. For example, entry point 410 may be a link or reference associated with an advertisement or promotion for a particular application.

In at least one of the various embodiments, testing engine 406 may be provided entry point 410 and convert/transform it to provide content from testing environment 408. In some embodiments, testing engine 406 may provide a particular mock/experimental landing page to the user based on the entry point information provided by the user. For example, entry point 410 may be a URL that testing engine 406 may map to a particular web page(s) in testing environment 408 that may be provided to the user that provided the entry point information.

In at least one of the various embodiments, entry point 410 may be associated with information for identifying the offered applications, the source of the entry point, user device information, user information, or the like. For example, in some embodiments, if the entry point is a URL there may be one or more values appended and/or included in the URL that may be used to identify/track the user and/or other information associated with the campaign.

In at least one of the various embodiments, if a user selects an offering from a landing page provided by testing engine 406, the user may be enabled to purchase the offered applications or services. In some embodiments, testing engine 406 may send or otherwise re-direct the user from testing environment 408 (e.g., experimental landing page, experimental mock app store, or the like) to a service, such as, application store 412 so they may actually purchase the offered application.

In at least one of the various embodiments, application store 412 may be operated by a third party that is not associated with testing system 400. In some embodiments, application store 412 may be a digital marketplace that may be authorized by one or more other organization for selling/delivering applications, media, or the like, to consumers. For example, application store 412 may represent the Apple App Store, Google Play (e.g., Google's digital marketplace). Microsoft's Windows Store, Amazon's Amazon Appstore, or the like. Accordingly, in many embodiments, application stores, such as, application store 412 may have limited integration features and may cutoff the tracking and monitoring done by testing engine 406. In some embodiments, application store 412 may be arranged to communicate some purchase information to measurement engine 402 indicating that the user has purchased the offered application. The type of information that may be provided by application store 412 to measurement engine 402 may be limited depending on the policy of the application store owners/operators. Also, in some embodiments, the primary catalog of offerings presented by application store 412 may be stored in a cloud based environment. Accordingly, in some embodiments, the user may execute an application store client on their client computer that enables the user to select, purchase, download, and install the offered application on the client computer (e.g., smart phone, desktop computer, tablet computer, or the like).

In at least one of the various embodiments, once the offered application is downloaded onto the user's client computer it may be unavailable to the testing engine. However, an application running on a client computer, application 414 may be arranged to communicate user interactions to measurement engine 402. In at least one of the various embodiments, depending on the available information, measurement engine 402 may be enabled correlate the measurement information provided by testing engine 406 and measurement information provided by installed application 414.

In at least one of the various embodiments, installed application 414 may include a metrics engine (e.g., metrics engine 223A, metrics engine 416, or the like) that may be arranged to communicate one or more events to measurement engine 402. In at least one of the various embodiments, events may include information for associating the event information with the source device.

In some embodiments, the particular information used for associating the client computer with the event may depend on the particular client computer being used. In some embodiments, different operating systems of client computers may dictate the type of information and/or its availability to its metrics engine. For example, some client computer operating systems may limit or otherwise restrict the type of information that may be gathered by metrics engine 416 for providing to measurement engine 402. Further, some operating systems may enable the user to modify the information sharing permissions of their client computer and/or for each application.

In at least one of the various embodiments, metrics engines, such as metrics engine 416 may be integrated into client applications using libraries, modules, plug-ins, or the like, that are compiled in the application. Further, in some embodiments, metrics engines may be installed on the client computers separate from application 414. For example, in some embodiments, metrics engine 414 may be installed as a separate application and/or included/integrated with the client computer operating system.

In some embodiments, metrics engines may provide APIs that enable the application development to communicate various events to a measurement engine. Accordingly, client application developers may arrange their applications to communicate events that represent users' activity during their interactions with the installed application.

In at least one of the various embodiments, metrics engine 416 may provide one or more interfaces that enables applications to provide events and communicate them to measurement engine 402. In at least one of the various embodiments, applications may be arranged to provide custom event labels, tags, description, or the like, that may be relevant to the application. Also, in some embodiments, one or more standard fields, such as, timestamps, source computer information (e.g., OS version, device type, device model, or the like), one or more device identifiers, or the like. In at least one of the various embodiments, privacy policies and/or privacy facilities of client computers and/or client computer operations may restrict the type of identifying information that may be included in an event. Is some embodiments, client computers vendors (or operation system develops) provide special identifiers that are allowed for use by vendors/advertisers for tracking application usages/interactions on client computers rather than unique identifiers that may be hardwired to a user's client computer, such as MAC addresses, MIEN, or the like. For example, in some embodiments, client computer operating system IOS enables applications to use a provided Identifier for Advertisers (IFA) and/or an Identifier for Vendors (IFV) to identify client computer. Likewise, the Android operating system provides Google Advertising ID (AID). One of ordinary skill in the art will appreciate that various operating systems may be arranged to provide a variety of different types of identifiers that may be included in an event. In some embodiments, the metrics engine may be arranged to default to using the appropriate identifier for a given client computer. In other embodiments, application developers may be enabled/required to provide the appropriate identifiers to the metrics engine.

Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), a Google AdID, combinations thereof, and the like. By way of a non-limiting example, the IMEI may be an Android IMEI. By way of another non-limiting example, the MEID may be an Android MEID. Another example of a device identifier is a value assigned to the end user client computer by system 400.

In some embodiments, other information associated with one of a client computer may also be used as device identifying information, and may include an Internet Protocol (IP) Address, browser information (e.g., browser type, browser version, a cookie, etc.), or the like, or combinations thereof In some embodiments, this other information may be usable to identify a user's client computer, though the other information may be less reliable.

In at least one of the various embodiments, if an application is installed on a client computer, the metrics engine may communicate one or more events corresponding to the installation to the measurement engine. Also, application may be arranged to employ the metrics engine to send events each time the application is launched on a client computer. Accordingly, in some embodiments, identifiers included in the events may be employed to correlate actions occurring on the installed application with test measurements that may be associated with one or more tests provided in testing environment 408.

In at least one of the various embodiments, by correlating events provided from installed applications with user activity measured by testing system 404, advertisers or marketers may analyze how their different experiments (e.g., different application landing pages) may relate to actual user activity.

In at least one of the various embodiments, measurement engines, such as measurement engine 402 may be arranged to provide one or more reports, such as, report 418 that enable advertisers, marketers, application developers, or the like, to analyze how the testing events relate to user generated events. In some embodiments, report 418 may be generated based on one or more queries provided by a user. In other embodiments, report 418 may include all events associated with one or more applications. In some embodiments, report 418 may be provided other external applications the provide visualization tools, analytics analysis, or the like. Likewise, in some embodiments, measurement engines may provide one or more visualization tools and/or one or more analysis tools for analyzing collected event information. Also, in some embodiments, report 418 may represent an interactive graphical user-interface that enables users to perform analysis in real-time or near real-time using queries, reports, graphs, filters, or the like.

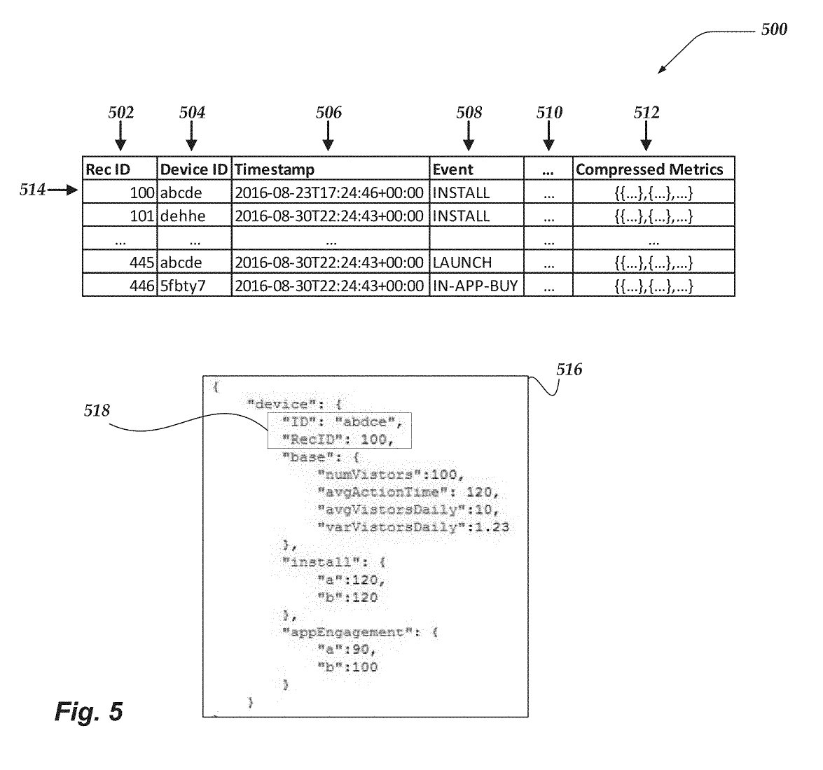

FIG. 5 illustrates logical architecture for compact self-referential data store 500 in accordance with at least one of the various embodiments. In at least one of the various embodiments, a measurement engine, such as measurement engine 322 or measurement engine 402 may be arranged to store information in one or more data stores. In at least one of the various embodiments, the particular arrangement of the data structure used to represent the information may be optimized to improve performance of the processors and/or computers performing one or more actions associated with a measurement engine.

In some embodiments, data store 500 may include one or more records, such as, record 514, that may include one or more fields, such as, record ID 502, device ID 504, timestamp 506, event label 508, various other fields 510, compressed metrics field 512, or the like. One of ordinary skill in the art will appreciate that for one or more embodiments the particular fields in data store 500 may vary significantly while remaining within the scope of the claim subject. Accordingly, in some embodiments, there may be more or fewer fields and/or one or more fields may have different labels and/or order in the data store. For example, in some embodiments, data store 500 may include a field for identifying the type of device identifier that is used. Accordingly, other fields 510 represents different and/or additional fields that may be part of an event data structure/data record.

In some embodiments, data store 500 may include one or more special fields, such as, compressed metrics field 512. In some embodiment, compressed metrics field 512 may be arranged to store another data structure that may represent one or more other fields. In this example, field 512 may be arranged to store one or more metrics associated with a client computer and/or its associated events.

In at least one of the various embodiments, compress metric data structure 516 may be representative of a data structure that may be used for storing metric information that may be associated with an event, installed application, client computer, or the like. As illustrated here, data structure 516 may include one or more fields representing metrics that may be tracked by a measurement engine. In this example, data structure 516 is represented using JavaScript object notation (JSON). Accordingly, in this example, the compressed fields may include values for tracking/measuring various user activity that may be associated with one or more events associated with installed applications.

In at least one of the various embodiments, arranging data store 500 to use compressed fields, such as, compressed metrics field 512 provide various improvements associated with the operation of a network computer that may be performing the action of a measurement engine. In some embodiments, employing compressed fields may reduce the complexity of the underlying data structure used by the data store. For example, compressed field 512 enables multiple values and/or value types to be stored in a single column of data store 500. Also, in this example, if JSON is used in the compressed field, the compressed fields may be rapidly instantiated as JavaScript objects that may readily be used in front-end (e.g., web browser JavaScript engines) or back-end services applications (e.g., node applications running on servers). Similarly, converting live objects into JSON representations suitable for storing in data store may employ one or more custom or native process that may be highly optimized for speed, size, or the like. For example, since JSON is a well-known standard, many different development environment, operating systems, or the like, may provide optimized facilities for generating JSON representation and/or generating object from JSON data.

Further, in at least one of the various embodiments, compressed fields, such as, compressed metrics field data structure 516 enable the measurement engine to provide a flexible data store, such that fields may be added to the compressed field without requiring a change to the data store's data schema.

Also, in at least one of the various embodiments, compressed field data structures, such as, compress field data structure 516 may be arranged to include self-referential information that enables the compressed field data structure to be reference back to its data store record and of the device ID stored in the data store. Accordingly, in some embodiments, an object that has access to the compressed fields may be enabled to identify the data store record its data store records and/or its associated client computer. For example, for some embodiment, compressed field data structure 516 may be arranged to include referential fields 518 that enable a measurement engine to associate compressed field data structure 516 with record 514 of data store 500.

In at least one of the various embodiments, the referential data incorporated in a compressed field may enable the compressed field to operate independent of the data store until the measurement engine persists the compressed fields into the data structure.

### Generalized Operations

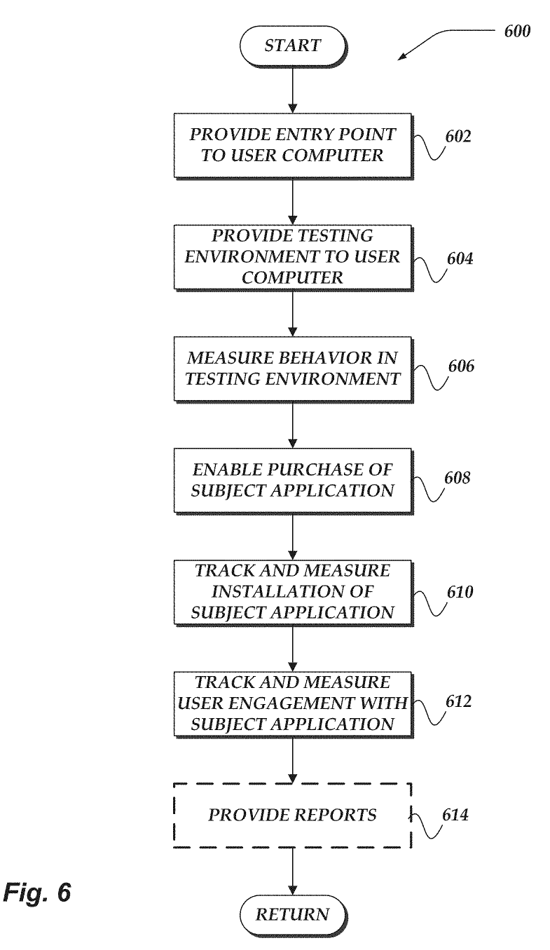

FIGS. 6-9 represent the generalized operations for application store optimization in accordance with at least one of the various embodiments. In at least one of the various embodiments, processes 600, 700, 800, or 900 described in conjunction with FIGS. 6-9 may be implemented by and/or executed by one or more processors on a single network computer, such as network computer 300 of FIG. 3. In other embodiments, these processes, or portions thereof, may be implemented by and/or executed on a plurality of network computers, such as network computer 300 of FIG. 3. In yet other embodiments, these processes, or portions thereof, may be implemented by and/or executed on one or more virtualized computers, such as, those in a cloud-based environment. However, embodiments are not so limited and various combinations of network computers, client computers, or the like may be utilized. Further, in at least one of the various embodiments, the processes described in conjunction with FIGS. 6-9 may be used for application store optimization in accordance with at least one of the various embodiments and/or architectures such as those described in conjunction with FIGS. 4-5. Further, in at least one of the various embodiments, some or all of the actions performed by processes 600, 700, 800, or 900 may be executed in part by measurement engine 322 and/or testing engine 324 running on one or more processors of one or more network computers.

FIG. 6 illustrates an overview flowchart for process 600 for application store optimization in accordance with at least one of the various embodiments. After a start block, at block 602, in at least one of the various embodiments, an entry point may be provided to a user computer. In some embodiments, a user computer may be a client computer, such as a mobile computer, smart phone, desktop computer, or the like.

In at least one of the various embodiments, the entry point may be a URL or other type of link that may be provided to a user. In some embodiments, the user may encounter the entry point while browsing the web, interacting with another application, via email, or the like.

In at least one of the various embodiments, the entry point may be arranged to navigate a user application, such as, a web browser to the testing system.

At block 604, in at least one of the various embodiments, the testing system may provide a testing environment to the user. As discussed early, the testing system may include a testing engine that may be arranged to execute one or more experiments that may include presenting a particular “landing page” to the user. In some embodiments, the landing page may be a mock application store landing page for an application. For example, upon the users following and/or activating the entry point, the test engine may select a landing page based on various criteria and present it to the user. In some embodiments, the testing environment provided to the user may be comprised more than one page and/or view.

At block 606, in at least one of the various embodiments, the testing engine may monitor user interaction with the testing environment. In at least one of the various embodiments, the test system may be configured to execute one or more experiments that compare how users behave given different landing pages (e.g., testing environments).

In at least one of the various embodiments, the testing engine may be arranged generate one or more events that may be provided to the measurement engine. Accordingly, in some embodiments, one or more events corresponding or associated different user interactions may be provided to the measurement engine. In at least one of the various embodiments, the measurement engine may store the provided events and attempt to associated with them with the user's client computer and/or the user.

At block 608, in at least one of the various embodiments, the testing environment may be arranged to enable to user to purchase (or download) the application that may be the subject of the experiments. For example, the landing page provided by the testing environment may be associated with one or more application that a user may be enabled to purchase or download. Accordingly, the testing engine may direct (e.g., navigate) the user to an actual application store that offers the subject application.

In some embodiments, the mock landing pages (for testing) may be arranged to look like application store landing pages for the subject application. Thus, if the user selects the “purchase” action on the mock landing pages, they may be navigated to an actual application store that enable them to purchase the application. For example, if a user is using viewing the mock landing pages using a web browser on their mobile computer, triggering a purchase, buy, or download action on the mock landing page may cause the actual application store landing page for the subject application to be launched one the user's client computer. This enables the user to complete the purchase of the application using the appropriate application store.

In at least one of the various embodiments, the method and/or depth of integration with the application store may vary depending on the policies and/or features of the application store operators. In some embodiments, the application store may be launched as a separate application on the user's client computer. Accordingly, in some embodiments, the application store integration may enable the testing engine to provide information in addition to the application identifier. In other embodiments, the application store may be arranged strictly limit the amount of information that may be passed to the application store.

In particular, in some embodiments, for new application install the application store may be configured to restrict the testing engine from passing information except for an application identifier that corresponds to the subject application that the user is attempting to purchase or install. Accordingly, the application store may use the provided application identifier to present the actual application store landing page for the subject application, enabling to the user to download and install the subject application onto their client computer.

In at least one of the various embodiments, the application identifier scheme used by the application store may be set during the configuration of the experiment performed by the testing engine. For example, if an application is accepted for offering by an application store, the application owner (e.g., the application developer) may be provided an application identifier that corresponds to the application.

At block 610, in at least one of the various embodiments, the measurement engine may be arranged to track or measure installations of the subject application. In at least one of the various embodiments, the subject application may be arranged to employ its embedded metrics engine to provide installation events to the measurement engine. In some embodiments, one or more installation events may be provided the first time the application is opened or activated by a user. In other embodiments, the client computer operating system may provide a facility the enables the metrics engine to provide an installation event to the measurement engine.

In at least one of the various embodiments, the measurement engine may be arranged to employ information included in the events to correlate the installed subject applications with events provided to the measurement engine. In some embodiments, events may include device ID information that may be used to correlate testing engine events with the installation events for a given client computer.

In at least one of the various embodiments, if the device ID information is not available, the testing engine may derive a substitute device ID from a generated fingerprint that may be used to correlate events with the user's client computer. In at least one of the various embodiments, fingerprints may be generated based on one or more visible properties/characteristics of the user's client computer, such as, client computer type, client application features (e.g., user-agent information), operating system version, or the like, or combination thereof. Accordingly, the device ID derived from the fingerprint information may be used by the measurement engine to associate events with client computers. Also, in some embodiments, the fingerprint information may be based in part on one or more characteristics of the user's interactions. For example, in some embodiments, information provided in a HTTP user-agent field may be included in the fingerprint information.

In some embodiments, the fingerprint may be associated with a defined time window, such as, 2 hours, 12 hours, 5 days, or the like. Thus, if events associated by fingerprints are provided to the measurement engine outside of the defined time window, the measurement engine may be arranged to treat the fingerprint as a new/separate client computer.

At block 612, in at least one of the various embodiments, as the user interacts with the installed application one or more events may be communicated to the measurement engine. These events may be specific to the particular requirements and design goals of the application developer. Accordingly, in some embodiments, different applications may be arranged to communicate different events at different times based on how the application developers have programmed their application. For example, in some embodiments, the subject application may be programmed to provide an event each time a user uses a particular feature of the subject application.

In at least one of the various embodiments, the metrics engine may be arranged to provide the events to the measurement engine. In some embodiments, the events may include various information for identifying the user client computer. Accordingly, the events may be correlated with testing engine events that may be stored on the measurement engine for the same client computer.

In at least one of the various embodiments, the some or all of the metric information may be stored in one or more compressed fields, as shown in FIG. 5.

At block 614, optionally, in at least one of the various embodiments, the measurement engine may provide one or more reports to application owners, marketers, advertisers, or the like. In at least one of the various embodiments, the measurement engine may be arranged to provide a user-interface or API the enables report queries to be provided. In some embodiments, in response to the report queries, the measurement engine may provide a result set of event information corresponding to query parameters included in the report query.

In some embodiment, the measurement engine may be arranged to support report queries that may include SQL-like features that include, result set columns, where clause filters, source/origin filters (e.g., similar to SQL table values), functions, formatting, or the like, or combination thereof. However, the report queries are not limited to SQL-like languages or query structure, other query languages, formatting, or structures may be used.

In at least one of the various embodiments, the reports may be provided to other services or applications that may perform further analysis of the event information collected by the measurement engine. Accordingly, in some embodiments, reports may be formatted to be compatible with these other applications, such format may include, text files, fixed length formatted text, comma separated values (CSV), extensible markup language (XML), JavaScript object notation (JSON), or the like, combination thereof.

In at least one of the various embodiments, as described above (See, FIG. 5), portions of the event information may be stored in one or more compressed fields. Accordingly, in some embodiments, the compressed values may be expanded or inflated to appear as normal fields in the result set. For example, if the requested report format requires flat records, each compressed field value may be expanded into its own column in the result set. In some embodiments, the result set may be a collection of objects (e.g., using JSON). Accordingly, the compress fields may be expanded into objects rather than flattened into individual values. Next, control may be returned to a calling process.

In at least one of the various embodiments, compressed fields enable the schema of the event data store to accept different metric types without modification. Further, in some embodiments, since compressed fields may be self-referential, their containing event record may be determined from the object created from the compressed field data as needed.

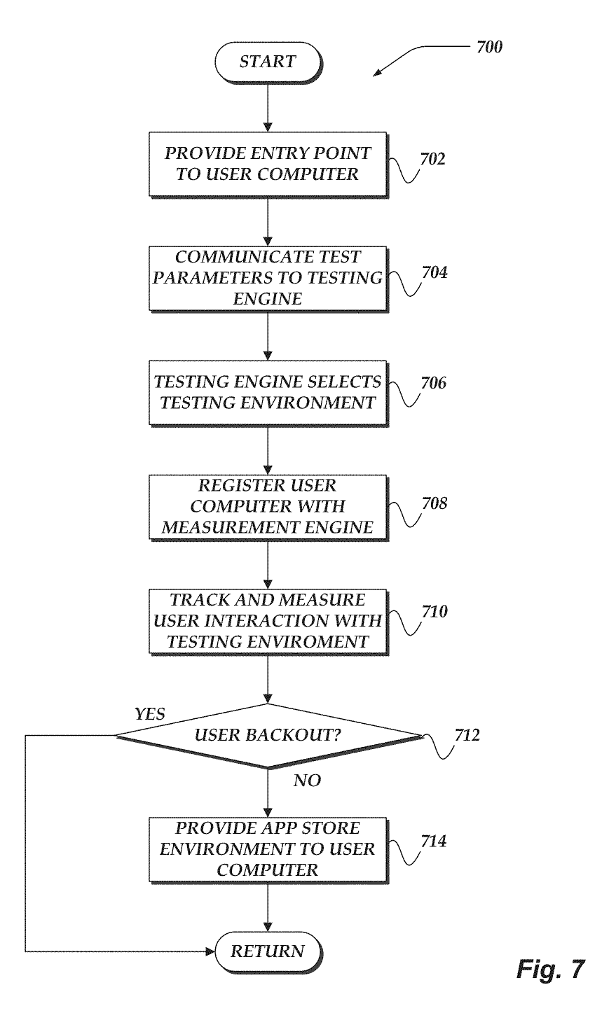

FIG. 7 illustrates an overview flowchart for process 700 for collecting test measurements for application store optimization in accordance with at least one of the various embodiments. After a start block, at block 702, in at least one of the various embodiments, an entry point may be provided to the user computer. As described above the entry point may be a URL or other linking/navigation facility that enables a user to navigate to the testing system. For example, entry points may be URLs (links) provided by web-page banner advertisements, in application advertisements, URL in emails, or the like.

At block 704, in at least one of the various embodiments, one or more test parameters may be provided to the testing engine. In at least one of the various embodiments, the entry point may be arranged to include one or more parameters that may be used to initialize an experiment. For example, if the entry point is a URL, various components of the URL, such as hostname, path values, query string parameters, POST fields, HTTP headers, HTTP cookies, or the like, may be arranged to include test parameter values.

In at least one of the various embodiments, test parameters may include one or more tracking IDs that identify the source of the entry point. For example, in some embodiments, the entry point may be associated with a campaign or experiment for a particular application developer. Accordingly, in some embodiments, the test parameters may include an identifier for the application developer and an identifier for the campaign or experiment.

At block 706, in at least one of the various embodiments, the testing engine may select a testing environment to provide to the user. In at least one of the various embodiments, the testing engine may select a testing environment based on in part on the provided test parameters. In some embodiments, an experiment may be configured that a defined percentage of users are sent to a testing environment with the remainder being sent to the actual application store. Accordingly, the testing engine may randomly determine if a user may participate in an experiment based on the percentage value. For example, an application developer may design an experiment that is assigned 20% of users. Accordingly, for this example, the testing engine may randomly select 20% of users to send to testing environments rather the actual application store. Likewise, in some embodiments, experiments may be designed that apply to all users coming from entry points associated with an application.

In at least one of the various embodiments, the testing engine may employ various rules defined in the experiment to select a particular testing environment for the user. In some embodiments, if the application developer (or marketer) has more than one active experiment that may be associated with different campaigns and/or different entry points. Accordingly, in at least one of the various embodiments, test parameters provided by the entry point may be used to select an experiment. For example, a test parameter may include a key value that indicates which experiment to use. In some embodiments, the application developer may have a single experiment active that may be automatically used for qualifying users.

For example, in some embodiments, test parameters may include user-agent information that may indicate the type of client computer, the type of client application used by the user (e.g., web browser, web browser version, or the like), the type and/or version of the operating system, or the like, or combination thereof. Accordingly, in some embodiments, the testing engine may select testing environments that are suited for the client computer, and such, used by the user. Also, in some cases, experiments may be targeted to a particular type of client computer such that other types of client computers may be passed directly to the actual application store.

In at least one of the various embodiments, the testing environment may be a selection of one or more web pages arranged to look and feel like an application store landing page for the subject application. The testing engine may be arranged to select the particular web pages for a user using one or probability based testing methodologies. In some embodiment, the particular testing methodology, experiment design, controls, test pages, or the like, may be selected by the application developer, marketer, or the like.

At block 708, in at least one of the various embodiments, the testing engine may register the user's client computer with the measurement engine. In at least one of the various embodiments, the testing engine may communicate information to measurement engine, such as, an event that indicates that the client computer is participating in an experiment.

In some embodiments, the testing engine may communicate a portion of the testing parameters to the measurement engine. In at least one of the various embodiments, these may include entry point identifiers, campaign identifiers, experiment/testing environment identifiers, device identifiers (if available), or the like. In at least one of the various embodiments, the testing engine may also include other event information such as, timestamps, event labels, event descriptions, event tags, or the like.

In at least one of the various embodiments, the measurement engine may register the client computer using the provided information. In some embodiments, the device ID may be used to track and record events that may be associated with the client computer. In some cases, the device ID may not be provided. For example, in some embodiments, users may restrict access to their device ID using privacy controls of their devices. In these cases, in some embodiments, the testing engine and/or the measurement engine may generate a value that may act as a fingerprint of the client computer. Accordingly, in some embodiments, the device ID may be derived from at least a portion of the fingerprint.

In at least one of the various embodiments, the fingerprint may be generated based on one or more properties/characteristics that are publically visible, such as, client computer type, client application (e.g., user-agent information), operating system version, or the like, or combination thereof. Accordingly, device ID derived from the fingerprint information may be used by the measurement engine to associate events with client computers.

In at least one of the various embodiments, the fingerprint may be generated by hashing or otherwise combining the fingerprint information into a format that may be easily stored, indexed, or compared with other fingerprints.

In some embodiments, the fingerprint may be associated with a defined time window, such as, 2 hours, 12 hours, 5 days, or the like. Thus, if events associated by fingerprints are provided to the measurement engine outside of the defined time window, the measurement engine may be arranged to treat the fingerprint as a new client computer.

At block 710, in at least one of the various embodiments, the testing engine may track and measure user interactions with the testing environment. In at least one of the various embodiments, the testing engine be arranged to monitor the activities of the user. Accordingly, each time a user performs an interaction of interest, the testing engine may be arranged to provide one or more corresponding events to the measurement engine. In at least one of the various embodiments, the number and type of events may vary depending on the arrangement and/or configuration of the testing environment.

For example, if the testing environments are web pages, the web page may include JavaScript programs, or the like, controls the experiment and/or that is arranged to monitor the local/in-browser activity of the user. If events are triggered by in-browser interactions, the JavaScript programs may be used to communicate relevant event information to the testing engine or to the measurement engine. Likewise, in some embodiments, a testing environment may include server-side monitoring that may provide events and/or direct the experiments behavior based on user interactions observed by the server-side of the testing environment.

In at least one of the various embodiments, the testing engine may employ one or more network protocols to communicate the events to the measurement engine. In some embodiments, the events may be packaged into data structures that are optimized for the employed network protocols. For example, if HTTP over TCP/IP is used for communication, the event information may be arranged and/or formatted using JSON.

Also, in some embodiments, the network connection between the testing engine and the measurement engine may be encrypted or otherwise, cryptographically secure. Likewise, in some embodiments, the event information may be encrypted before being communicated to the measurement engine.

At decision block 712, in at least one of the various embodiments, if the user backs out of the testing environment, control may be returned to a calling process; otherwise, control may flow to block 714. In at least one of the various embodiments, users may exit the testing environment rather than attempt to obtain the subject application. In some embodiments, the testing engine may monitor if users exit the testing environment. In some cases, the testing engine may be arranged to provide an event corresponding to the user exiting the testing environment. For example, the testing engine may be arranged to provide an explicit “back-out” event to the measurement engine if its connection to the client computer unexpectedly terminates. Likewise, in some embodiments, a testing engine may be arranged to provide exit events for client computers that do not interact with the testing environment within a defined time. Further, in at least one of the various embodiments, the testing environment (e.g., the mock landing page) may include a user-interface control that expressly allows the user back-out, exit, log-off, or the like. Accordingly, in some embodiments, exit events may be provided to the measurement engine if a user uses such a user-interface control.

Also, in at least one of the various embodiments, the testing engine and/or the measurement engine may be arranged to let client computers leave the testing environment without generating a back out event. Accordingly, the measurement engine may be used to identify back-outs by analyzing the events that were provided by the testing engine. For example, the measurement engine may identify back-outs by identifying client computers that have recorded “begin testing” events and have no corresponding recorded “purchase” event.

At block 714, in at least one of the various embodiments, the application store may be provided to the user's client computer. If the user does not back-out or otherwise pre-maturely exit the testing environment, they may eventually select/activate a user-interface control that indicates the user has decided to purchase or download the subject application. Accordingly, in some embodiments, the user may be directed to an actual application store that offers the subject application.

For example, if the mock landing page used in the experiment is a web page, the testing engine may redirect the user to a URL that will open the application store on the users' client computer.

In at least one of the various embodiments, the application store may be provided an identifier that corresponds to the subject application. Thus, the application store may be arranged to automatically open to the real landing page of the subject application. In some embodiments, the application store may accept additional install parameter information, such as, referrer IDs, campaign IDs, callback actions, or the like, or combination thereof. In some embodiments, one or more of the install parameters may be provided to the subject application. However, the allowed install parameters and their meaning may vary depending on the application store. Though in many cases, application stores enable very limited information to passed from the point of purchase to the subject application. Next, control may be returned to a calling process.

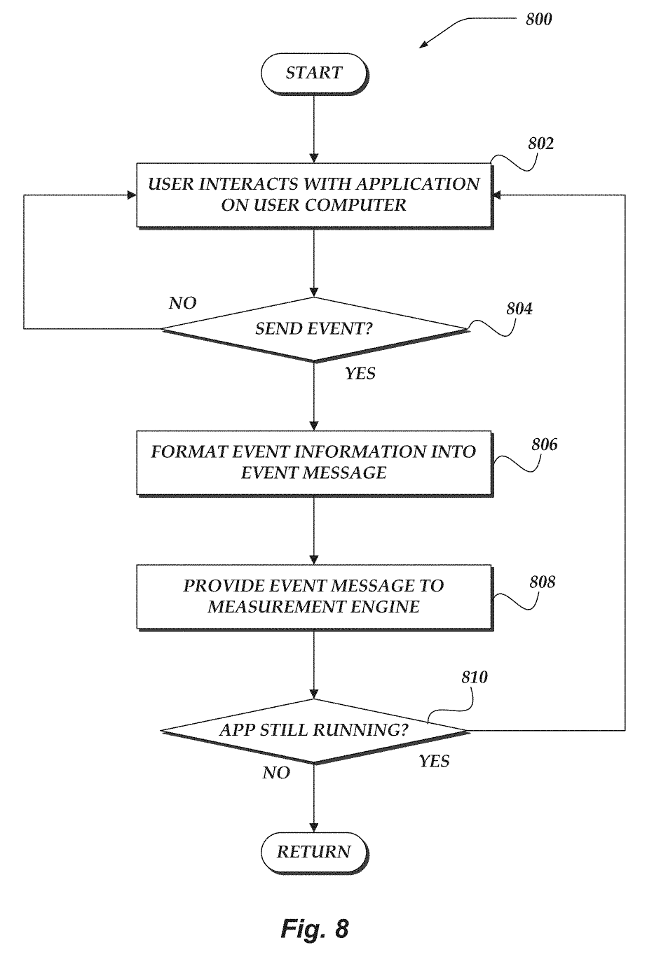

FIG. 8 illustrates an overview flowchart for process 800 for collecting test measurements for application store optimization in accordance with at least one of the various embodiments. After a start block, at block 802, in at least one of the various embodiments, a user may interact with a subject application on their client computer. If a user has installed the subject application on their client computer, they may interact with it according to the design of the subject application.

In at least one of the various embodiments, interactions may include launching the application, performing various task in the application by interacting with its user interface, performing in-application purchases, or the like, or combination thereof.

At decision block 804. in at least one of the various embodiments, if the application provides an event, control may flow to block 806; otherwise, control may loop back to block 802. In at least one of the various embodiments, the application developers that created the subject application may have programmed the subject application to provide one or more events depending on the interactions of the user and/or the operation of the subject application. As described above, events may be associated with various user interactions and/or application behavior.

At block 806, in at least one of the various embodiments, the event information may be formatted into one or more event messages. In at least one of the various embodiments, the application developer programs the subject application to arrange/configure at least a portion of the information included in the event. Also, in some embodiments, the metrics engine may be arranged to require particular fields or values be provided. Accordingly, in at least one of the various embodiments, the subject application may provide an event that is formatted according to the restrictions of the metrics engine and the pre-programmed instructions provided by the application developer.

In at least one of the various embodiments, the subject application may be arranged to communicate with the metrics engine of the application via an API or other programmable interface. If the subject application provides the required information to the metrics engine it may generate an event and prepare it for communication to the measurement engine. In at least one of the various embodiments, the metrics engine may accept the provided information and/or add additional information to complete the construction of the event.

In at least one of the various embodiments, the metrics engine may transform the event into a data-interchange format that is suitable for communicating over the network to the measurement engine. In some embodiments, the specific formatting may vary depending on the type of information included in the event, the size of the event, network protocols being used, or the like, or combination thereof. For example, in some embodiments, the metrics engine may transform the event into JSON to support communicating the event information to the measurement engine using HTTP on TCP/IP. In at least one of the various embodiments, the event information may be transformed into one or more data exchange formats to enable it to be received and/or processed using a different process or programming language than used by the subject application.

In at least one of the various embodiments, some or all of the event information may be encrypted or otherwise secured before it is provided to the measurement engine.

At block 808, in at least one of the various embodiments, the one or more event messages may be provided to the measurement engine. In at least one of the various embodiments, the event information may be communicated to the measurement engine over a network. In some embodiments, the metrics engine may employ a public-key infrastructure to enable secure communication of the event information to the measurement engine. For example, in at least one of the various embodiments, the metrics engine may employ SSL or TLS to securely communicate the event information to the measurement engine.

At decision block 810, in at least one of the various embodiments, if the subject application is still running, control may loop back to block 802; otherwise, control may be returned to a calling process. In at least one of the various embodiments, the subject application may be arranged to provide events as long as the subject application is running on the client computer of the user.

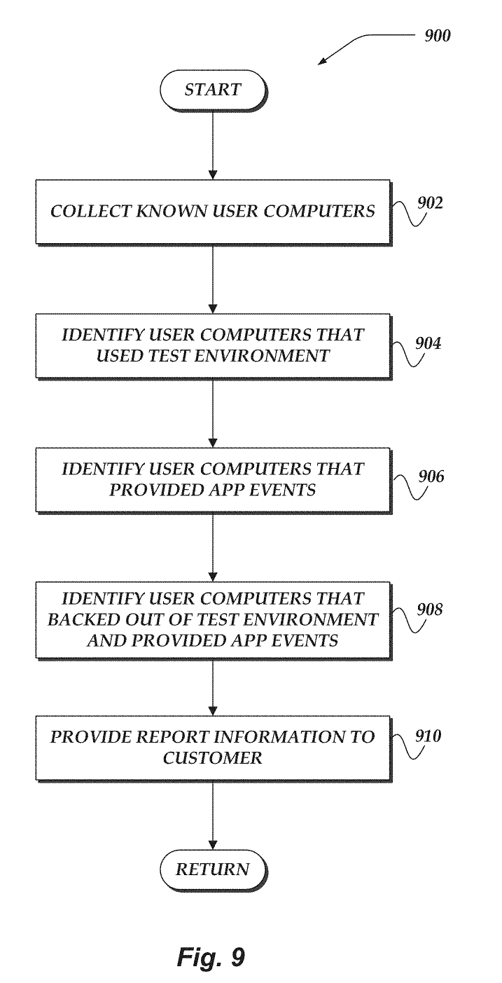

FIG. 9 illustrates an overview flowchart for process 900 for collecting test measurements for application store optimization in accordance with at least one of the various embodiments. After a start block, at block 902, in at least one of the various embodiments, collect list of known user client computers. In at least one of the various embodiments, the measurement engine may be arranged to maintain a list or database of each client computer that has provided event information associated with the subject application. In at least one of the various embodiments, lists of client computers may be further segmented based on various factors, such as, type of client computer, operating system, time of day the events occurred, type of events, geographic source of event, or the like, or combination thereof.

At block 904, in at least one of the various embodiments, identify user client computers that used testing environments. In at least one of the various embodiments, the measurement engine may be arranged to filter the list of client computers based on if they may be associated with one or more testing environment events stored by the measurement engine.

In at least one of the various embodiments, these client computers may be determined based on the type of events (or event source) that the measurement engine has received for a client computer. In some embodiments, event types, event sources, or event names associated with the testing engine events or testing environments events may be defined in configuration information.

At block 906, in at least one of the various embodiments, identify user client computers that provided application events to measurement engine. In at least one of the various embodiments, these client computers may be determined based on the type of events that the measurement engine has received for a given client computer. In some the event types or event names associated with application events may be defined in configuration information. Or, in some embodiments, application events may be considered to be events that are not associated with the testing engine or a testing environment.

At block 908, in at least one of the various embodiments, identify user client computers that backed out of testing environments and later provided application events. In at least one of the various embodiments, the measurement engine may be arranged to provide a list of client computers that interacted with a testing environment and provided one or more test events but for some reason the user did not follow through and purchase or download the subject application using the testing environment. For example, the user may have navigated to a testing environment and then left the testing environment before completing a purchase of the subject application. Accordingly, the measurement engine may have some test events recorded for the client computer, but no test events corresponding to the user making a purchase of the subject application.

Likewise, in at least one of the various embodiments, if the user has installed the subject application outside of using the testing environment, the measurement engine may have application events associated with the user's client computer. Accordingly, in some embodiments, the measurement engine may provide a list of client computers associated with some test events, except for purchase/install test events and some application events for the subject application. These represent client computers that declined to purchase/obtain the subject application via the testing environment and yet ultimately purchased/obtained the subject application from another source without going through the testing environment.

At block 910, in at least one of the various embodiments, provide report information to customers. In at least one of the various embodiments, the event information for the client computers that exited the testing environment before completing a purchase and yet obtained the subject application independent of the testing engine may be formatted into a report and provided to a user. In some embodiments, the report may be in the form of graphical user-interface, or it may be in text, comma separated values (CSV), extensible markup language (XML), JavaScript object notation (JSON), or the like, combination thereof. Next, control may be returned to a calling process.

It will be understood that each block of the flowchart illustration, and combinations of blocks in the flowchart illustration, can be implemented by computer program instructions. These program instructions may be provided to one or more processors, including one or more special purpose processers to produce a machine, such that the instructions, which execute on the one or more processors, create means for implementing the actions specified in the flowchart block or blocks. The computer program instructions may be executed by the one or more processors to cause a series of operational steps to be performed by the one or more processors to produce a computer-implemented process such that the instructions, which execute on the one or more processors to provide steps for implementing the actions specified in the flowchart block or blocks. The computer program instructions may also cause at least some of the one or more processors to perform the operational steps shown in the blocks of the flowchart in parallel. Moreover, some of the steps may also be performed across more than one processor, such as might arise in a multi-processor computer system and/or multi-core hardware processor. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of actions for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

Further, in one or more embodiments (not shown in the figures), the logic in the illustrative flowcharts may be executed using one or more embedded logic hardware devices instead of a CPU, such as, an Application Specific Integrated Circuit (ASIC), Field Programmable Gate Array (FPGA), Programmable Array Logic (PAL), or the like, or combination thereof. The one or more embedded logic hardware devices may directly execute embedded logic to perform actions described above. In at least one embodiment, one or more microcontrollers may be arranged to directly execute their own embedded logic to perform actions and access their own internal memory and their own external Input and Output Interfaces (e.g., hardware pins and/or wireless transceivers) to perform actions, such as System On a Chip (SOC), or the like.

1. A method for managing user interactions with applications over a network using a network computer having one or more processors that perform actions, comprising:
when a user employs a client computer to interact with an entry point to a testing environment, performing further actions, including:
providing two or more test events to a measurement engine based on one or more user interactions with two or more different landing pages that include one or more mock landing pages are provided by the testing environment, wherein the two or more test events include one or more device identifiers that correspond to the client computer, and wherein a testing engine provides content for the one or more mock pages based on a mapping of a particular web page in the testing environment to a Uniform Resource Locator (URL) and other information that is associated with the user's entry point
in response to an interaction by the user with the content in a mock landing page for an application, automatically navigating the user away from the mock landing page to a separate landing page that launches an online store that provides access to the application from the client computer, wherein the mock landing page's content is arranged to visually appear to provide various functions associated with a landing page but instead it's only function is to automatically navigate the user to the separate landing page in response to the user's interaction with the content of the mock landing page; and
configuring and arranging a non-transitory computer readable media to store the one or more test events; and
when the user interacts with the application on the client computer separate from the testing environment, performing further actions, including:
providing one or more application events to the measurement engine based on one or more other user interactions with the application, wherein the one or more application events include at least the one or more device identifiers; and
employing the measurement engine to correlate the one or more test events with the one or more application events based on the one or more device identifiers; and
providing one or more reports associated with the application, wherein the reports include information that is based on the one or more test events and the one or more application events.

2. The method of claim 1, further comprising employing a testing engine to provide the testing environment associated with the application.

3. The method of claim 1, further comprising:
providing a fingerprint of the client computer based on one or more characteristics of one or more of the client computer or the one or more user interactions; and
deriving the one or more device identifiers from at least a portion of the fingerprint.

4. The method of claim 1, wherein providing the one or more test events, further comprises:
providing at least one test event that corresponds to the user requesting to install the application; and
employing a testing engine to redirect the client computer to an application store that offers the application, wherein the application store is separate from the testing engine and the measurement engine.

5. The method of claim 1, further comprising:
providing one or more metrics based on the one or more test events and the one or more application events;
packing the one or more metrics into one or more compressed fields; and
storing the one or more compressed fields in a record that is associated with the application.

6. The method of claim 1, wherein providing the one or more reports associated with the application, further comprises, providing a list of client computers that provided one or more of the one or more application events absent a test event corresponding to a request to install the subject application.

7. The method of claim 1, wherein providing the one or more application events to the measurement engine, further comprises:
providing user interaction information to a metrics engine on the client computer, wherein the metrics engine is included in the application;
employing the metrics engine to generate the one or more application events; and
employing the metrics engine to communicate the one or more application events to the measurement engine.

8. The method of claim 1, further comprising, employing a testing engine to register the client computer with the measurement engine.

9. A system for managing user interactions with applications, comprising:
a network computer, comprising:
a transceiver that communicates over the network;
a memory that stores at least instructions; and
one or more processor devices that execute instructions that perform actions, including:
when a user employs a client computer to interact with an entry point to a testing environment, performing further actions, including:
providing two or more test events to a measurement engine based on one or more user interactions with two or more different landing pages that include one or more mock landing pages are provided by the testing environment, wherein the two or more test events include one or more device identifiers that correspond to the client computer, and wherein a testing engine provides content for the one or more mock pages based on a mapping of a particular web page in the testing environment to a Uniform Resource Locator (URL) and other information that is associated with the user's entry point
in response to an interaction by the user with the content in a mock landing page for an application, automatically navigating the user away from the mock landing page to a separate landing page that launches an online store that provides access to the application from the client computer, wherein the mock landing page's content is arranged to visually appear to provide various functions associated with a landing page but instead it's only function is to automatically navigate the user to the separate landing page in response to the user's interaction with the content of the mock landing page; and
configuring and arranging a non-transitory computer readable media to store the one or more test events; and
when the user interacts with the application on the client computer separate from the testing environment, performing further actions, including:
providing one or more application events to the measurement engine based on one or more other user interactions with the application, wherein the one or more application events include at least the one or more device identifiers; and
employing the measurement engine to correlate the one or more test events with the one or more application events based on the one or more device identifiers; and
providing one or more reports associated with the application, wherein the reports include information that is based on the one or more test events and the one or more application events; and
a client computer, comprising:
a client computer transceiver that communicates over the network;
a client computer memory that stores at least instructions; and
one or more processor devices that execute instructions that perform actions, including:
executing the application; and
communicating the one or more application events to the measurement engine.

10. The system of claim 9, wherein the one or more network computer processor devices execute instructions that perform actions, further comprising, employing a testing engine to provide the testing environment associated with the application.

11. The system of claim 9, wherein the one or more network computer processor devices execute instructions that perform actions, further comprising:
providing a fingerprint of the client computer based on one or more characteristics of one or more of the client computer or the one or more user interactions; and
deriving the one or more device identifiers from at least a portion of the fingerprint.

12. The system of claim 9, wherein providing the one or more test events, further comprises:
providing at least one test event that corresponds to the user requesting to install the application; and
employing a testing engine to redirect the client computer to an application store that offers the application, wherein the application store is separate from the testing engine and the measurement engine.

13. The system of claim 9, wherein the one or more network computer processor devices execute instructions that perform actions, further comprising:
providing one or more metrics based on the one or more test events and the one or more application events;
packing the one or more metrics into one or more compressed fields; and
storing the one or more compressed fields in a record that is associated with the application.

14. The system of claim 9, wherein providing the one or more reports associated with the application, further comprises, providing a list of client computers that provided one or more of the one or more application events absent a test event corresponding to a request to install the subject application.

15. The system of claim 9, wherein providing the one or more application events to the measurement engine, further comprises:
providing user interaction information to a metrics engine on the client computer, wherein the metrics engine is included in the application;
employing the metrics engine to generate the one or more application events; and
employing the metrics engine to communicate the one or more application events to the measurement engine.

16. The system of claim 9, wherein the one or more network computer processor devices execute instructions that perform actions, further comprising, employing a testing engine to register the client computer with the measurement engine.

17. A processor readable non-transitory storage media that includes instructions for managing user interactions with application, wherein execution of the instructions by one or more hardware processors performs actions, comprising:
when a user employs a client computer to interact with an entry point to a testing environment, performing further actions, including:
providing two or more test events to a measurement engine based on one or more user interactions with two or more different landing pages that include one or more mock landing pages are provided by the testing environment, wherein the two or more test events include one or more device identifiers that correspond to the client computer, and wherein a testing engine provides content for the one or more mock pages based on a mapping of a particular web page in the testing environment to a Uniform Resource Locator (URL) and other information that is associated with the user's entry point
in response to an interaction by the user with the content in a mock landing page for an application, automatically navigating the user away from the mock landing page to a separate landing page that launches an online store that provides access to the application from the client computer, wherein the mock landing page's content is arranged to visually appear to provide various functions associated with a landing page but instead it's only function is to automatically navigate the user to the separate landing page in response to the user's interaction with the content of the mock landing page; and
configuring and arranging a non-transitory computer readable media to store the one or more test events; and
when the user interacts with the application on the client computer separate from the testing environment, performing further actions, including:
providing one or more application events to the measurement engine based on one or more other user interactions with the application, wherein the one or more application events include at least the one or more device identifiers; and
employing the measurement engine to correlate the one or more test events with the one or more application events based on the one or more device identifiers; and
providing one or more reports associated with the application, wherein the reports include information that is based on the one or more test events and the one or more application events.

18. The media of claim 17, further comprising employing a testing engine to provide the testing environment associated with the application.

19. The media of claim 17, further comprising:
providing a fingerprint of the client computer based on one or more characteristics of one or more of the client computer or the one or more user interactions; and
deriving the one or more device identifiers from at least a portion of the fingerprint.

20. The media of claim 17, wherein providing the one or more test events, further comprises:
providing at least one test event that corresponds to the user requesting to install the application; and
employing a testing engine to redirect the client computer to an application store that offers the application, wherein the application store is separate from the testing engine and the measurement engine.

21. The media of claim 17, further comprising:
providing one or more metrics based on the one or more test events and the one or more application events;
packing the one or more metrics into one or more compressed fields; and
storing the one or more compressed fields in a record that is associated with the application.

22. The media of claim 17, wherein providing the one or more reports associated with the application, further comprises, providing a list of client computers that provided one or more of the one or more application events absent a test event corresponding to a request to install the subject application.

23. The media of claim 17, wherein providing the one or more application events to the measurement engine, further comprises:
providing user interaction information to a metrics engine on the client computer, wherein the metrics engine is included in the application;
employing the metrics engine to generate the one or more application events; and
employing the metrics engine to communicate the one or more application events to the measurement engine.

24. A network computer for managing user interactions with applications, comprising:
a transceiver that communicates over the network;
a memory that stores at least instructions; and
one or more processor devices that execute instructions that perform actions, including:
when a user employs a client computer to interact with an entry point to a testing environment, performing further actions, including:
providing two or more test events to a measurement engine based on one or more user interactions with two or more different landing pages that include one or more mock landing pages are provided by the testing environment, wherein the two or more test events include one or more device identifiers that correspond to the client computer, and wherein a testing engine provides content for the one or more mock pages based on a mapping of a particular web page in the testing environment to a Uniform Resource Locator (URL) and other information that is associated with the user's entry point
in response to an interaction by the user with the content in a mock landing page for an application, automatically navigating the user away from the mock landing page to a separate landing page that launches an online store that provides access to the application from the client computer, wherein the mock landing page's content is arranged to visually appear to provide various functions associated with a landing page but instead it's only function is to automatically navigate the user to the separate landing page in response to the user's interaction with the content of the mock landing page; and
configuring and arranging a non-transitory computer readable media to store the one or more test events; and
when the user interacts with the application on the client computer separate from the testing environment, performing further actions, including:
providing one or more application events to the measurement engine based on one or more other user interactions with the application, wherein the one or more application events include at least the one or more device identifiers; and
employing the measurement engine to correlate the one or more test events with the one or more application events based on the one or more device identifiers; and
providing one or more reports associated with the application, wherein the reports include information that is based on the one or more test events and the one or more application events.

25. The network computer of claim 24, further comprising employing a testing engine to provide the testing environment associated with the application.

26. The network computer of claim 24, further comprising:
providing a fingerprint of the client computer based on one or more characteristics of one or more of the client computer or the one or more user interactions; and
deriving the one or more device identifiers from at least a portion of the fingerprint.

27. The network computer of claim 24, wherein providing the one or more test events, further comprises:
providing at least one test event that corresponds to the user requesting to install the application; and
employing a testing engine to redirect the client computer to an application store that offers the application, wherein the application store is separate from the testing engine and the measurement engine.

28. The network computer of claim 24, further comprising:
providing one or more metrics based on the one or more test events and the one or more application events;
packing the one or more metrics into one or more compressed fields; and
storing the one or more compressed fields in a record that is associated with the application.

29. The network computer of claim 24, wherein providing the one or more reports associated with the application, further comprises, providing a list of client computers that provided one or more of the one or more application events absent a test event corresponding to a request to install the subject application.

30. The network computer of claim 24, wherein providing the one or more application events to the measurement engine, further comprises:
providing user interaction information to a metrics engine on the client computer, wherein the metrics engine is included in the application;
employing the metrics engine to generate the one or more application events; and
employing the metrics engine to communicate the one or more application events to the measurement engine.
